(19) United States
(12) Patent Application Publication
(10) Pub. No.: US 2022/0134793 A1
(43) Pub. Date: May 5, 2022

(54) OPTICAL ANTI-COUNTERFEITING ELEMENT AND ANTI-COUNTERFEITING PRODUCT

(71) Applicants: ZHONGCHAO SPECIAL SECURITY TECHNOLOGY CO., LTD, Beijing (CN); CHINA BANKNOTE PRINTING AND MINTING CORP., Beijing (CN)

(72) Inventors: Xin Qu, Beijing (CN); Baoli Zhang, Beijing (CN); Jun Zhu, Beijing (CN)

(21) Appl. No.: 17/310,863

(22) PCT Filed: Feb. 28, 2020
(86) PCT No.: PCT/CN2020/077200

§ 371 Date: Aug. 27, 2021

(30) Foreign Application Priority Data
Feb. 28, 2019 (CN) 201910152315.0

(51) Int. Cl. B42D 25/328; B42D 25/324; B42D 25/351

(52) U.S. Cl. CPC B42D 25/328; B42D 25/351; B42D 25/324

(57) ABSTRACT

Disclosed are an optical anti-counterfeiting element and an anti-counterfeiting product. The optical anti-counterfeiting element includes: a substrate, the substrate including a first surface and a second surface opposite each other; a first micro-embossment structure at least partially covering the first surface, the first micro-embossment structure including a first micro-lens array and a first micro-graph array; and a second micro-embossment structure at least partially covering the second surface, the second micro-embossment structure including a second micro-lens array and a second micro-graph array; and wherein the first micro-lens array is configured to sample and synthesize the second micro-graph array, so as to form a first reproduced image, and the second micro-lens array is configured to sample and synthesize the first micro-graph array, so as to form a second reproduced image. According to the anti-counterfeiting element, a sampled and enlarged reproduced image may be observed from both sides of the substrate separately.

### CROSS-REFERENCE TO RELATED APPLICATION

The disclosure is a United States national phase patent application based on PCT/CN2020/077200 filed on Feb. 28, 2020, which claims priority to and the benefit of Chinese Patent Present invention No. 201910152315.0, filed in the China National Intellectual Property Administration (CNIPA) on Feb. 28, 2019, which is incorporated herein by reference in its entirety.

### TECHNICAL FIELD

The disclosure relates to the field of optical anti-counterfeiting, and in particular to an optical anti-counterfeiting element and an anti-counterfeiting product.

### BACKGROUND

Due to its unique visual effect and recognizability, an optical anti-counterfeiting element is widely applied to high-security products such as banknotes, credit cards, passports and securities, as well as other high value-added products.

The micro-lens array type anti-counterfeiting technology utilizes a micro-lens as a micro-sampling tool to sample a corresponding micro-graph. A dynamic enlarged image being animated and visible is presented by designing sampling points under different observation angles. Disclosed in the patent documents such as CN 101563640A, CN 101120139A, U.S. Pat. No. 5,712,731A, and CN 102958705A is the same type of anti-counterfeiting element in which two surfaces of a substrate are provided with a micro-lens array and a micro-graph array separately. Such an anti-counterfeiting element can only be observed from one side of the substrate, and the micro-lens array performs a moire enlargement on the micro-graph array, so as to reproduce a pattern with a certain depth of field or dynamic effect. However, features cannot be observed from the other side (micro-graph array side).

Also disclosed in CN 101563640A is an embodiment in which an anti-counterfeiting element is observed from both sides. Two surfaces of a substrate are provided with a micro-lens array and a micro-graph array separately, and then two or three layers of substrates are compounded. The anti-counterfeiting element of this structure has the following disadvantages:
(1) a plate-making process is complicated, and it is required to manufacture a plurality of original plates for micro-lens arrays and micro-graph arrays on different surfaces separately;
(2) in a production process, it is required to align the micro-lens array with the micro-graph array repeatedly, so the process is more complicated and the controllability is poor; and
(3) a thickness of the anti-counterfeiting element is greatly increased, which is not conducive to the design and application of some high-security products.

### SUMMARY

The embodiment of the disclosure aims to provide an optical anti-counterfeiting element and an anti-counterfeiting product, which are configured to solve or at least partially solve the technical problems described as above.

In order to realize the objectives described as above, the embodiment of the disclosure provides an optical anti-counterfeiting element. The optical anti-counterfeiting element includes: a substrate, the substrate including a first surface and a second surface opposite each other; a first micro-embossment structure at least partially covering the first surface, the first micro-embossment structure including a first micro-lens array and a first micro-graph array; and a second micro-embossment structure at least partially covering the second surface, the second micro-embossment structure including a second micro-lens array and a second micro-graph array; and wherein the first micro-lens array is configured to sample and synthesize the second micro-graph array, so as to form a first reproduced image, and the second micro-lens array is configured to sample and synthesize the first micro-graph array, so as to form a second reproduced image.

Accordingly, the embodiment of the disclosure further provides an anti-counterfeiting product using the optical anti-counterfeiting element described as above.

Each of the optical anti-counterfeiting element and the anti-counterfeiting product using the optical anti-counterfeiting element provided by the embodiment of the disclosure includes the substrate and micro-embossment structures on two surfaces of the substrate, each of the micro-embossment structures including the micro-lens array and the micro-graph array, and the micro-lens arrays on the two surfaces sampling and enlarging the micro-graph arrays on the other surfaces separately, so as to form the reproduced images. The disclosure has the following advantages: (1) observing the sampled and enlarged reproduced image from both sides of the substrate separately realizes better anti-counterfeiting performance and visual effect than observing from only one side; (2) the micro-lens array and the micro-graph array on one surface are manufactured on the same original plate, so the quantity and complexity of the original plate to be manufactured are reduced for the anti-counterfeiting element which is configured to be observed from both sides; (3) during production, it is only required to perform alignment once, so process difficulty is the same as that of an anti-counterfeiting element observed from one side, and a process flow is simple; and (4) since the total layer number of the micro-lens array or micro-graph array and the layer number of the substrate are not increased, the anti-counterfeiting element has no increase in thickness compared with the element observed from one side, thereby being suitable for being applied to various anti-counterfeiting products.

Other features and advantages of the embodiment of the disclosure will be described in detail in the specific implementation that follows.

### BRIEF DESCRIPTION OF THE DRAWINGS

The accompanying drawings, which are used for providing further understanding of the embodiment of the disclosure and constitute a part of the description, together with the following specific implementation, serve to explain the embodiment of the disclosure instead of limiting same. In the accompanying drawings:

FIG. 1 shows a cross-sectional view of an optical anti-counterfeiting element according to one implementation of the disclosure;

FIGS. 2A-2D show schematic diagrams of different types of micro-graph arrays;

FIG. 3 shows a cross-sectional view of an optical anti-counterfeiting element according to another implementation of the disclosure;

FIG. 4 shows a cross-sectional view of an optical anti-counterfeiting element according to yet another implementation of the disclosure;

FIG. 5 shows one arrangement mode of a micro-lens array and a corresponding micro-graph array of the other surface;

FIG. 6 shows another arrangement mode of the micro-lens array and the corresponding micro-graph array of the other surface; and

FIG. 7 shows a cross-sectional view of an optical anti-counterfeiting element according to yet another implementation of the disclosure.

### DETAILED DESCRIPTION OF THE EMBODIMENTS

The specific implementation of the embodiment of the disclosure is described in detail below in conjunction with the accompanying drawings. It should be understood that the specific implementation described herein is merely illustrative of the embodiment of the disclosure and is not intended to limit the embodiment of the disclosure.

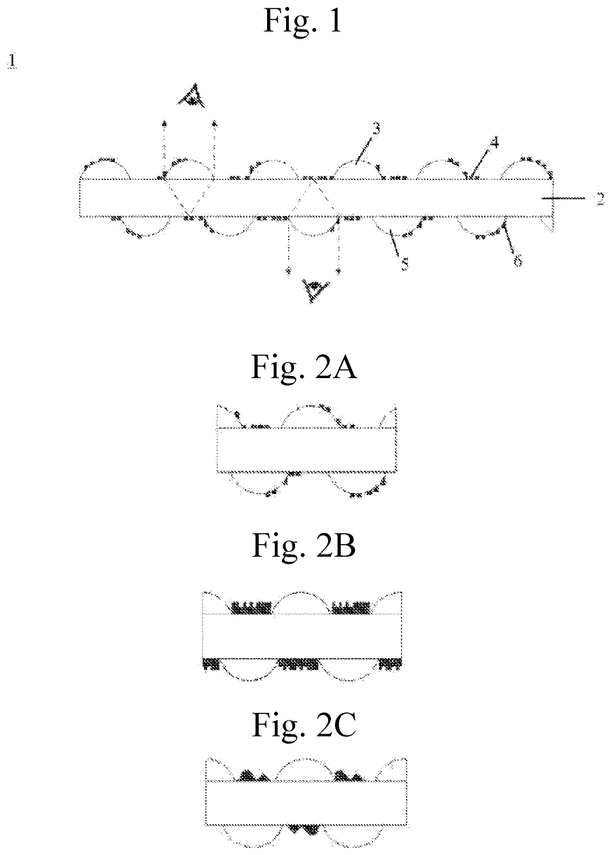

FIG. 1 schematically shows an optical anti-counterfeiting element 1 of one implementation of the disclosure. The optical anti-counterfeiting element 1 according to the implementation of the disclosure includes: a substrate 2, the substrate 2 including a first surface and a second surface opposite each other; a first micro-embossment structure located on the first surface of the substrate 2, the first micro-embossment structure at least partially covering the first surface of the substrate 2 and including a first micro-lens array 3 and a first micro-graph array 4, the first micro-graph array 4 fully or partially overlapping a surface of the first micro-lens array 3; and a second micro-embossment structure located on the second surface of the substrate 2, the second micro-embossment structure at least partially covering the second surface of the substrate 2 and including a second micro-lens array 5 and a second micro-graph array 6, the second micro-graph array 6 fully or partially overlapping a surface of the second micro-lens array 5. The first micro-lens array 3 is configured to sample and synthesize the second micro-graph array 6, so as to form a reproduced image. The second micro-lens array 5 is configured to sample and synthesize the first micro-graph array 4, so as to form a reproduced image.

The first micro-lens array 3 and/or the second micro-lens array 5 shown in FIG. 1 is a spherical micro-lens array. However, it should be understood by those skilled in the art that the first micro-lens array 3 and the second micro-lens array 5 may be one or more of an aperiodic array, a random array, a periodic array, and a locally periodic array composed of a plurality of micro-lens units. The micro-lens unit may be a refractive micro-lens, a diffractive micro-lens or any combination thereof, wherein the refractive micro-lens may be a spherical micro-lens, an ellipsoidal micro-lens, a cylindrical micro-lens or any other geometric optics-based micro-lenses with any geometric shape, the diffractive micro-lens may be a harmonic diffractive micro-lens, a planar diffractive micro-lens or a Fresnel zone plate, and certainly, in addition to the Fresnel zone plate, it is also possible to select a continuous curved surface type or a stepped surface type structure as the micro-lens unit. In addition, the first micro-lens array 3 and the second micro-lens array 5 may be composed of one or more forms of the micro-lens units described as above.

A surface micro-structure used by a micro-graph array in the first micro-graph array 4 and/or the second micro-graph array 6 may be composed of at least one of a diffractive micro-embossment structure, a non-diffractive micro-embossment structure and a scattering structure. A specific shape may be any surface micro-structure having, but not limited to, the following features: one or more continuous curved structures, one or more rectangular structures, one or more sawtooth-shaped prisms, or a splice or combination thereof.

The first micro-graph array 4 and/or the second micro-graph array 6 may be one or more of an aperiodic array, a random array, a periodic array, or a locally periodic array composed of a plurality of micro-graph units. The micro-graph unit may be composed of one or more of a convex micro-graph unit, a concave micro-graph unit, a relief embossment unit or a periodic relief grating micro-graph unit, wherein the first micro-graph array 4 and the second micro-graph array 6 may use the same or different types of micro-graph units.

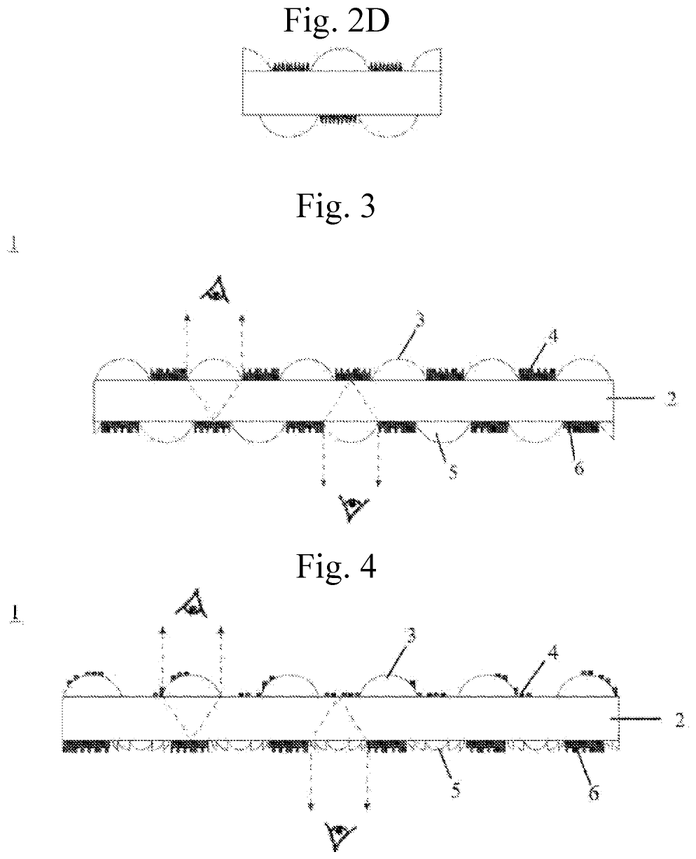

FIG. 2A shows a schematic diagram of the convex micro-graph unit. As shown in FIG. 2A, the convex micro-graph unit may cover a surface of the micro-lens unit, or a gap between the micro-lens units on the surface of the substrate. FIGS. 2B-2D show the schematic diagrams of the concave micro-graph unit, the relief embossment unit and the periodic relief grating micro-graph unit separately. as shown in FIGS. 2B-2D, the concave micro-graph unit, the relief embossment unit and the periodic relief grating micro-graph unit may preferably cover only the gap between the micro-lens units on the surface of the substrate.

The first micro-graph array 4 and the second micro-graph array 6 may be formed of a micro-structure covering the surface of the micro-lens array (including the micro-lens unit and the gap between the micro-lens units). The micro-graph array shown in FIG. 1 is composed of the convex micro-graph unit formed on the surface of the micro-lens unit and in the gap between the micro-lens units.

The first micro-graph array 4 and the second micro-graph array 6 may also cover only the gap between the micro-lens units instead of the surface of the micro-lens unit, which is shown in FIG. 3, in which the first micro-graph array 4 and the second micro-graph array 6 are composed of the concave micro-graph units. In this case, an entire surface of the micro-lens may be configured for optical imaging, so as to improve definition of the sampled and synthesized reproduced image.

Preferably, the first micro-lens array 3 and the second micro-lens array 5 may use different types of micro-lens units, and the first micro-graph array 4 and the second micro-graph array 6 may use different types of micro-graph units or micro-graph embossment structures. FIG. 4 shows one possible case, in which the first micro-lens array 3 and the first micro-graph array 4 on the first surface of the substrate 2 are a continuous spherical micro-lens array and a micro-graph array composed of the convex micro-graph unit respectively; and the second micro-lens array 5 and the second micro-graph array 6 on the second surface of the substrate 2 are a micro-lens array composed of a Fresnel lens and a micro-graph array composed of the concave micro-graph unit respectively.

Preferably, the first micro-lens array 3 and the second micro-lens array 5 may select different arrangement modes separately, to exhibit different reproduction effects as observed from both sides of the substrate while reducing or eliminating interference between the micro-lens array and the micro-graph array on the same surface of the substrate. Accordingly, corresponding to the first micro-lens array 3 and the second micro-lens array 5, the second micro-graph array 6 and the first micro-graph array 4 select different arrangement modes.

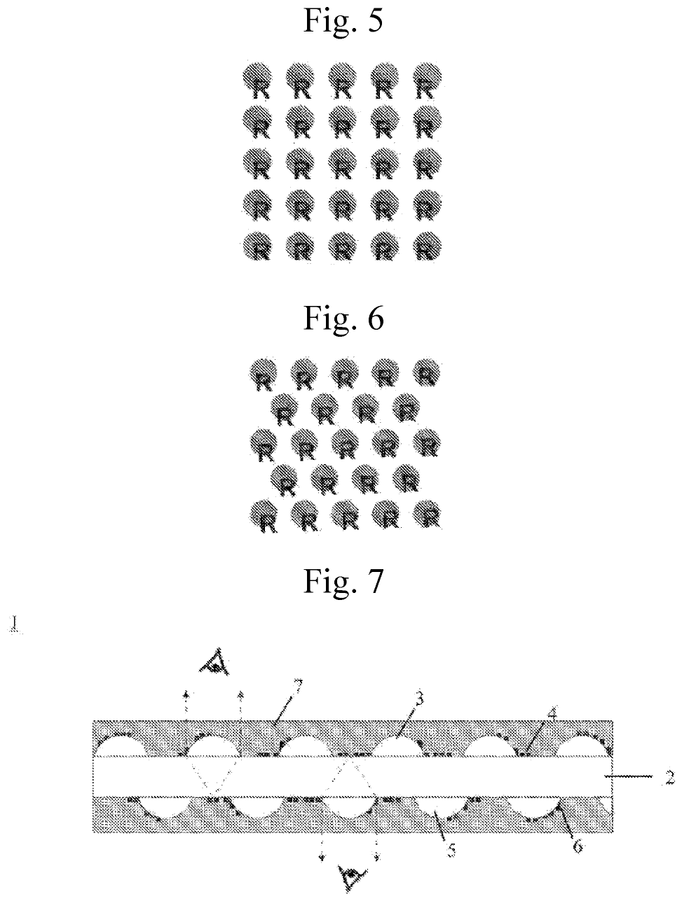

FIG. 5 schematically shows an arrangement mode of a continuous spherical first micro-lens array 3 and a second micro-graph array 6 overlapping and corresponding to same on the other surface, in which arrangement periods of the quadrilateral periodically arranged first micro-lens array 3 and the quadrilateral periodically arranged second micro-graph array 6 have a slight difference, so as to be within a range of reproduction based on sampling and synthesizing, and in particular, further satisfy a condition of a moire enlargement. FIG. 6 schematically shows another arrangement mode of a continuous spherical second micro-lens array 5 and a first micro-graph array 4 overlapping and corresponding to same on the other surface, in which arrangement directions of the hexagonal periodically arranged second micro-lens array 5 and the hexagonal periodically arranged first micro-graph array 4 are relatively and slightly staggered, so as to be within the range of reproduction based on sampling and synthesizing, and in particular, further satisfy the condition of the moire enlargement.

Preferably, a period of the periodic or partially periodic micro-lens array 3, second micro-lens array 5, first micro-graph array 4, and second micro-graph array 6 according to the implementation of the disclosure may be 5-200 microns, preferably 20-100 microns, and a focal length of the first micro-lens array 3 and the second micro-lens array 5 may be 5-200 microns, preferably 10-100 microns.

Preferably, a machining depth of the micro-embossment structure according to the disclosure may be less than 30 microns. More preferably, a height of the micro-lens may be not greater than 20 microns, and a machining depth of a micro-graph may preferably be 0.2-10 microns.

An original plate of the micro-embossment structure including the first micro-lens array 3 and the first micro-graph array 4, or an original plate of the micro-embossment structure including the second micro-lens array 5 and the second micro-graph array 6 may be implemented through a micro-machining process. Particularly, the original plate may be implemented through processes such as ultraviolet lithography exposure, laser direct writing exposure, electron beam direct writing exposure, and reactive ion etching, and may also be implemented in combination with processes such as hot melt reflow. But it should be understood that their implementation methods are not limited to the methods described as above. Preferably, surface micro-structures of the micro-lens array and the micro-graph array included in the optical anti-counterfeiting element 1 of the implementation of the disclosure are made at one time through one process or mutual cooperation among a plurality of micro-machining processes described as above. The micro-lens array and the micro-graph array are simultaneously copied in a production procedure of subsequent batch copying (for example, using an imprint process of an ultraviolet curing material), without involving separate step-by-step copying of the micro-lens array and the micro-graph array.

Preferably, the substrate 2 in the optical anti-counterfeiting element 1 according to the disclosure may be a colorless or colored medium layer which is at least partially transparent, or the substrate 2 may be a layer of single lens medium film, such as a PET film and a BOPP film. Certainly, it can also be a transparent medium film with a functional coating layer (such as an imprint layer) on the surface, or a multilayer film formed through compounding.

Preferably, the micro-embossment structure of the optical anti-counterfeiting element 1 of the disclosure may be coated with a protective layer and/or a bonding layer. For example, FIG. 7 shows an example in which the surface with the first micro-lens array 3 and the first micro-graph array 4 and the surface with the second micro-lens array 5 and the second micro-graph array 6 of the optical anti-counterfeiting element 1 are coated with the protective layer 7. The protective layer or the bonding layer is formed to protect the optical anti-counterfeiting element 1 according to the implementation of the disclosure against an external environment or bond the optical anti-counterfeiting element 1 according to the implementation of the disclosure to an anti-counterfeiting product in consideration of application. Therefore, when the protective layer and the bonding layer are formed, the bonding layer is arranged outside the protective layer (that is, the protective layer is closer to the micro-embossment structure), so as to bond the optical anti-counterfeiting element of the disclosure to carriers such as a banknote and paper. The protective layer and/or the bonding layer is bonded to the anti-counterfeiting product. The protective layer and/or the bonding layer may cover part or all of the surface that it coats. When the protective layer and/or the bonding layer is in direct contact with the micro-embossment structure according to the implementation of the disclosure, a refractive index of the protective layer or the bonding layer is smaller than that of the micro-embossment structure in contact, and a difference between the refractive index of the protective layer or the bonding layer and the refractive index of the micro-embossment structure is greater than or equal to 0.3. It should be noted that, during practical application, the difference between the refractive index of the protective layer or the bonding layer and the refractive index of the micro-embossment structure is generally smaller than a difference between a refractive index of a material forming the micro-embossment structure and a refractive index of air, which places higher demands on the micro-lens as a focusing element, for example, a diameter of a bottom surface of the micro-lens needs to be smaller, and a height of the micro-lens needs to be larger.

Preferably, the protective layer or the bonding layer is at least translucent.

Preferably, the protective layer or the bonding layer has a function of increasing a color effect, so as to improve expressive force of the sampled and synthesized reproduced image. For example, an ink, a pigment, a dye, a liquid crystal, a fluorescent material, etc. may be used to make the function of the color effect, and may be implemented, for example, through coating, printing, inkjet, dyeing, deposition, etc.

The optical anti-counterfeiting element 1 according to the implementation of the disclosure is particularly suitable for manufacturing an anti-counterfeiting transparent window product which may be observed from both sides. The anti-counterfeiting transparent window product is configured for anti-counterfeiting of various high-security products such as a banknote, a credit card, a passport and a security and high value-added products, as well as various packing paper, packing boxes, etc.

The optical anti-counterfeiting element 1 according to the disclosure may also be used as a label, a logo, a wide strip, a transparent window, a coating film, etc., and may be bonded to various articles through various bonding mechanisms, for example, transferred to the high-security product such as a banknote and a credit card and the high value-added product.

Another method for manufacturing an optical anti-counterfeiting element 1 according to the implementation of the disclosure includes: manufacturing a first micro-lens array 3 and a first micro-graph array 4 on one substrate, manufacturing a second micro-lens array 5 and a second micro-graph array 6 on the other substrate, and compounding the two substrates together through a compounding process publicly known in the art. When the two substrates are compounded, surfaces without micro-embossment are compounded together; and after compounding, a distance between the first micro-lens array 3 and the second micro-graph array 6 is equal to the sum of thicknesses of the two layers of substrates and a thickness of a compounding glue, and similarly, a distance between the second micro-lens array 5 and the first micro-graph array 4 is equal to the sum of the thicknesses of the two layers of substrates and the thickness of the compounding glue.

The implementation of the disclosure further provides an anti-counterfeiting product, which uses the optical anti-counterfeiting element described as above, such as a banknote, a credit card, a passport and a security.

The alternative implementation of the embodiment of the disclosure is described in detail above with reference to the accompanying drawings. However, the embodiment of the disclosure is not limited to specific details of the implementation described as above. Within the scope of the technical concept of the embodiment of the disclosure, various simple modifications can be made to the technical solution of the embodiment of the disclosure, and these simple modifications all fall within the scope of protection of the embodiment of the disclosure.

It should also be noted that various specific technical features described in the specific implementation described as above may be combined in any suitable manner, without contradiction. In order to avoid unnecessary repetition, the embodiment of the disclosure will not be described separately for various possible combinations.

In addition, various different implementations of the embodiment of the disclosure may also be combined randomly, so long as they do not deviate from the idea of the embodiment of the disclosure, and they should also be regarded as disclosed in the embodiment of the disclosure.

1.-15. (canceled)

16. An optical anti-counterfeiting element, comprising:
a substrate, comprising a first surface and a second surface opposite each other;
a first micro-embossment structure at least partially covering the first surface, the first micro-embossment structure comprising a first micro-lens array and a first micro-graph array; and
a second micro-embossment structure at least partially covering the second surface, the second micro-embossment structure comprising a second micro-lens array and a second micro-graph array; and
wherein the first micro-lens array is configured to sample and synthesize the second micro-graph array, so as to form a first reproduced image, and the second micro-lens array is configured to sample and synthesize the first micro-graph array, so as to form a second reproduced image.

17. The optical anti-counterfeiting element according to claim 16, wherein
the first micro-graph array fully or partially overlaps a surface of the first micro-lens array, the second micro-graph array fully or partially overlaps a surface of the second micro-lens array; or
the second micro-graph array fully or partially overlaps a surface of the second micro-lens array; or
the first micro-graph array fully or partially overlaps a surface of the first micro-lens array.

18. The optical anti-counterfeiting element according to claim 16, wherein
the first micro-lens array is one or more of an aperiodic array, a random array, a periodic array, or a locally periodic array composed of a plurality of micro-lens units; or
the second micro-lens array is one or more of an aperiodic array, a random array, a periodic array, or a locally periodic array composed of a plurality of micro-lens units; or
the first micro-lens array is one or more of an aperiodic array, a random array, a periodic array, or a locally periodic array composed of a plurality of micro-lens units, and the second micro-lens array is one or more of an aperiodic array, a random array, a periodic array, or a locally periodic array composed of a plurality of micro-lens units.

19. The optical anti-counterfeiting element according to claim 18, wherein the micro-lens unit is a refractive micro-lens and/or a diffractive micro-lens; and the first micro-lens array and the second micro-lens array use the same or different types of micro-lens units.

20. The optical anti-counterfeiting element according to claim 18, wherein a focal length of the micro-lens unit is 5-200 microns.

21. The optical anti-counterfeiting element according to claim 16, wherein
a surface micro-structure used by the first micro-graph array is composed of one or more of a diffractive micro-embossment structure, a non-diffractive micro-embossment structure and a scattering structure; or
a surface micro-structure used by the second micro-graph array is composed of one or more of a diffractive micro-embossment structure, a non-diffractive micro-embossment structure and a scattering structure; or
a surface micro-structure used by the first micro-graph array is composed of one or more of a diffractive micro-embossment structure, a non-diffractive micro-embossment structure and a scattering structure, and a surface micro-structure used by the second micro-graph array is composed of one or more of a diffractive micro-embossment structure, a non-diffractive micro-embossment structure and a scattering structure.

22. The optical anti-counterfeiting element according to claim 21, wherein the surface micro-structure is one or more continuous curved structures, one or more rectangular structures, one or more sawtooth-shaped prisms, or a splice or combination thereof.

23. The optical anti-counterfeiting element according to claim 16, wherein
the first micro-graph array is one or more of an aperiodic array, a random array, a periodic array, or a locally periodic array composed of a plurality of micro-graph units; or
the second micro-graph array is one or more of an aperiodic array, a random array, a periodic array, or a locally periodic array composed of a plurality of micro-graph units; or
the first micro-graph array is one or more of an aperiodic array, a random array, a periodic array, or a locally periodic array composed of a plurality of micro-graph units, and the second micro-graph array is one or more of an aperiodic array, a random array, a periodic array, or a locally periodic array composed of a plurality of micro-graph units.

24. The optical anti-counterfeiting element according to claim 23, wherein the micro-graph unit is composed of one or more of a convex micro-graph unit, a concave micro-graph unit, a relief embossment unit or a periodic relief grating micro-graph unit; and the first micro-graph array and the second micro-graph array use the same or different types of micro-graph units.

25. The optical anti-counterfeiting element according to claim 16, wherein a period of the periodic or locally periodic first micro-lens array, second micro-lens array, first micro-graph array and second micro-graph array is 5-200 microns.

26. The optical anti-counterfeiting element according to claim 16, wherein
a machining depth of the first micro-embossment structure and the second micro-embossment structure is less than 30 microns; and/or
a height of the first micro-lens array and the second micro-lens array is not greater than 20 microns; and/or
a machining depth of the first micro-graph array and the second micro-graph array is 0.2-10 microns.

27. The optical anti-counterfeiting element according to claim 16, further comprising a protective layer or bonding layer coating surfaces of the first micro-embossment structure and/or the second micro-embossment structure.

28. The optical anti-counterfeiting element according to claim 27, wherein the protective layer or the bonding layer is at least translucent.

29. The optical anti-counterfeiting element according to claim 27, wherein the protective layer or the bonding layer is configured to be configured to increase a color effect.

30. An anti-counterfeiting product using the optical anti-counterfeiting element according to claim 16.

31. The optical anti-counterfeiting element according to claim 20, wherein the focal length of the micro-lens unit is 10-100 microns.

32. The optical anti-counterfeiting element according to claim 25, wherein the period of the periodic or locally periodic first micro-lens array, second micro-lens array, first micro-graph array and second micro-graph array is 20-100 microns.

33. The anti-counterfeiting product using the optical anti-counterfeiting element according to claim 30, wherein
the first micro-graph array fully or partially overlaps a surface of the first micro-lens array, the second micro-graph array fully or partially overlaps a surface of the second micro-lens array; or
the second micro-graph array fully or partially overlaps a surface of the second micro-lens array; or
the first micro-graph array fully or partially overlaps a surface of the first micro-lens array.

34. The anti-counterfeiting product using the optical anti-counterfeiting element according to claim 30, wherein
the first micro-lens array is one or more of an aperiodic array, a random array, a periodic array, or a locally periodic array composed of a plurality of micro-lens units; or
the second micro-lens array is one or more of an aperiodic array, a random array, a periodic array, or a locally periodic array composed of a plurality of micro-lens units; or
the first micro-lens array is one or more of an aperiodic array, a random array, a periodic array, or a locally periodic array composed of a plurality of micro-lens units, and the second micro-lens array is one or more of an aperiodic array, a random array, a periodic array, or a locally periodic array composed of a plurality of micro-lens units.

35. The anti-counterfeiting product using the optical anti-counterfeiting element according to claim 34, wherein the micro-lens unit is a refractive micro-lens and/or a diffractive micro-lens; and the first micro-lens array and the second micro-lens array use the same or different types of micro-lens units.
